(19) United States
(12) Patent Application Publication
(10) Pub. No.: US 2003/0154322 A1
(43) Pub. Date: Aug. 14, 2003

(54) Electronic system for developing software and a method for accessing the internal data of said software

(76) Inventor: Horst Wagner, Stuttgart (DE)

Correspondence Address: KENYON & KENYON, ONE BROADWAY, NEW YORK, NY, 10004, US

(21) Appl. No.: 10/312,936

(22) PCT Filed: Jun. 20, 2001
(86) PCT No.: PCT/DE01/02276

(30) Foreign Application Priority Data
Jun. 30, 2000 (DE) 10030988.7

(51) Int. Cl. G06F 13/10; G06F 9/00

(52) U.S. Cl. 709/321; 709/327

(57) ABSTRACT

An electronic system is described for program development having a control unit and a storage medium which contains an application program (1, 2). Access to internal data of the application program (1, 2) to be developed is possible via interfaces. To that end, access points are provided in the application program (1, 2). Also stored in the storage medium is a configuration program which contains data that describe the interfaces and are allocated to the access points.

Moreover, a method is introduced which permits access to internal data of an application program (1, 2) to be developed.

A further subject matter of the invention is a data carrier, that is used as a storage medium for an electronic system, which has an application program (1, 2) having at least one access point and a configuration program, in which data for the description of interfaces are stored.

### BACKGROUND INFORMATION

The present invention relates to an electronic system for developing software according to the preamble of claim 1 and a corresponding method for accessing internal data of the software to be developed according to the preamble of claim 6. The invention also relates to a data carrier which is used as a storage medium for an electronic system.

When developing software, it is frequently necessary to observe and manipulate internal data of the application program to be developed. The development takes place on an electronic system for developing software, a development computer. Only after development is concluded is the completed application program transferred to the destination system.

Electronic systems for developing software have a control unit or ECU (electronic control unit). To discover errors in the program, and therefore to ensure a later error-free execution of the program, it is necessary to observe and possibly to manipulate internal data of the application software in the course of developing the application program. Only the direct access to internal data of the software to be developed from the beginning of the development to its conclusion can ensure that on the destination system, e.g. an embedded real-time system, the developed program will meet the demands that are placed. Demands are, for example, time demands. Especially for time-critical systems having hard real-time demands, it is unavoidable to precisely monitor the time behavior of the program already during the program development. To this end, it is necessary to both read and manipulate data.

The possibility of access (reading or writing) to internal data also permits an efficient rapid prototyping. Prototypes of new or altered application programs may be coupled to the existing structures. For example, prototypes allow the developer to test the program to be developed on the destination system before development is concluded. This can also be very useful for the later user of the program, since he is already able to check at a very early time and continually whether the program is as he imagined it.

So-called debuggers represent one possibility for accessing internal data. These are programs which, by checking internal data, discover errors and eliminate them. However, as a rule, debuggers are not suitable for problem posing, for which the time response of the ECU (electronic control unit), namely the CPU of the electronic system, must not be influenced. Because of external conditions, the use of debuggers in motor vehicles is often not possible. In addition, debuggers are as a rule not suitable for implementing function prototypes. An efficient rapid prototyping is therefore not possible.

Therefore, already within the framework of developing the application program, interfaces are implemented in it which, at a later time, i.e. at a later stage of the software development or during the run time of the application program, permit access to internal data. These implementations involve changes in the application program with regard to the special demands, which in turn has the result that individual software design approaches are frequently developed for different applications. The non-uniformity of design approaches, even for similar conceptual formulations, brings with it an increase of variants, and raises the need for maintenance and servicing.

A further disadvantage is that interfaces implemented in the course of the software development remain in the source text of the program and the executable code, even when they are no longer needed. This means a great demand on resources (program storage, volatile storage), which in turn has negative effects on the time response of the system and increases system costs. Moreover, such a procedure makes the documentation of programs and their intelligibility more difficult.

Therefore, the object of the present invention is to propose an electronic system for developing software which offers direct access to the internal data of the application program to be developed, while avoiding the disadvantages cited.

Moreover, the object of the present invention is to propose a method which permits direct access to the internal data of a program to be developed.

In addition, it is an object of the invention to develop a data carrier which may be used as storage medium for an electronic system for program development.

The objective with respect to the electronic system is achieved by such a one having the features of claim 1.

The objective with respect to the method is achieved by a method according to claim 6.

A data carrier for achieving the objective is yielded by claim 11.

Advantageous refinements of the present invention follow from the dependent claims.

### SUMMARY OF THE INVENTION

The starting point is an electronic system having a control unit and a storage medium which contains an application program to be developed. The electronic system has at its disposal at least one interface which permits access to internal data of the control unit. The system of the present invention has the distinction that at least one access point is provided in the application program, and a configuration program is stored in the storage medium. The configuration program contains data which describe the at least one interface and are allocated to the at least one access point in the application program.

The interface is therefore implemented in the source text of the application program and in the configuration program. During the development of the application program, only access points are introduced into it which permit later access to internal data. However, the data for the description of the interfaces is located in the configuration program. For an access to internal data, these data are expanded into the executable application program according to need. Referencing is implemented between the access point in the source text and the interface description in the configuration program by a clear identifier.

The effect of separating the interface information from the application program is that the source text of the application program does not have to be changed for different data accesses. Merely the configuration program has to be exchanged according to need. In addition, no resources are used in the application program and in the control unit when no interface is needed. This universal interface allows both reading and writing access to internal data. It is possible to consistently activate and deactivate the access points needed for an application.

The uniform instrumentation in the application program makes it possible to avoid variants of the source text modules for different interface demands. Examples for possible applications which use a universal interface are:

measuring points for program test and application;

stimulation interventions for the program test and frequency response measurements;

external bypass (prototype function is not calculated in the ECU);

internal bypass (prototype function is calculated in the ECU);

internal and external data loggers, respectively;

laboratory car software.

The mechanism of the universal interface is usable for offline and online applications under real-time conditions. In this context, the time response of the calculations is largely retained. The data consistency—causality between input and output quantities—corresponds to that of the program without interfaces.

The configuration program preferably has a global configuration file and at least one local configuration file. The at least one local configuration file contains the data for the description of the at least one interface. If a plurality of local configuration files is provided, they may each contain the data for the description of one of the interfaces. There may also be one or more local configuration files which contain data for no interface or access point. The global configuration file is higher-order and implements project-specific settings. This means that it selects interface descriptions, determined depending on the application, and assigns them to the corresponding access points in the application program. The interface descriptions are then expanded into the application program.

It is advantageous if the data for the description of the interfaces are grouped in the local configuration files. For example, this grouping may be based on the type of interface configuration (reading, writing). A functional grouping is also possible, so that individual functions of the application program may be selected. The expansion of individual groups is then controlled by settings in the global configuration file.

The expansion of individual groups is controlled, i.e. is introduced into the executable program or not, by these settings in the global configuration. For each individual interface description, the expansion is therefore evaluated as a logic operation of the group configurations to which it belongs.

For example, functional groupings make it possible to combine all accesses necessary for the frequency response analysis. Another possible grouping would be accesses for testing a controller. One interface description may belong to several groups. The grouping permits the consistent activation and deactivation of distributed descriptions of several interfaces by a single designation in the global configuration file. Therefore, the expansion of an interface application into the executable application program requires only the activation of the application-specific group, and translating and link-editing of the program. This is accomplished by the configuration program.

In one preferred refinement, the storage medium contains at least one device driver. It is connected to the application program by the linker. The drivers connected to the application program are compiled and, after the transfer of the application program to the destination system, are likewise located on it. For example, drivers may be device drivers for a serial interface or a CAN.

The access points are already implemented in the source text of the application program during the program development. In the case of a textual programming, the implementation is effected by a keyword. This objective may also be achieved by a suitable comment entry. When working with a graphical programming language, implementation is possible by a graphical structural element. In addition to the textual description of the interface configuration, input graphically or using a prompted menu is also possible.

The method of the present invention for accessing internal data of a control unit according to the preamble of claim 6 has the feature that for the access, data for the description of the at least one interface, which are stored in a configuration program in the storage medium, are allocated at least to one access point in the application program. According to the need, a configuration program is used which contains the data for the description of the necessary interfaces. They are then allocated to the corresponding access points in the application program. The internal data may subsequently be accessed.

The configuration program preferably has a global configuration file and at least one local configuration file. The local configuration files contain the data for the description of the interfaces. They are allocated to the access points in the application program corresponding to the data contained in the global configuration file. Thus, only the global configuration file must be exchanged for different applications.

If a plurality of local configuration files is provided, they may each contain the data for the description of one of the interfaces. It is possible that one or more local configuration files are provided without interface description.

The data in the local configuration files are preferably grouped.

The necessary device drivers are expediently stored in the storage medium. They are then linked to the application program upon access to the internal data. After the application program is compiled and transferred to the destination computer, the necessary device drivers remain in the application program and are therefore located in compiled form on the destination system.

The data carrier of the present invention is used as a storage medium for an electronic system for program development, which offers access to internal data of the program to be developed. The data carrier has an application program and a configuration program. At least one access point is implemented in the application program. The configuration program contains data for the description of the at least one interface.

The configuration program advantageously has a global configuration file and at least one local configuration file.

Preferably, at least one device driver is stored in the data carrier.

### BRIEF DESCRIPTION OF THE DRAWING

The invention is explained more precisely with reference to the attached Drawing, in which:

FIG. 1 shows a diagram for clarifying a preferred specific embodiment of the method according to the present invention;

FIG. 2 shows a schematic representation of a preferred specific embodiment of the electronic system according to the invention.

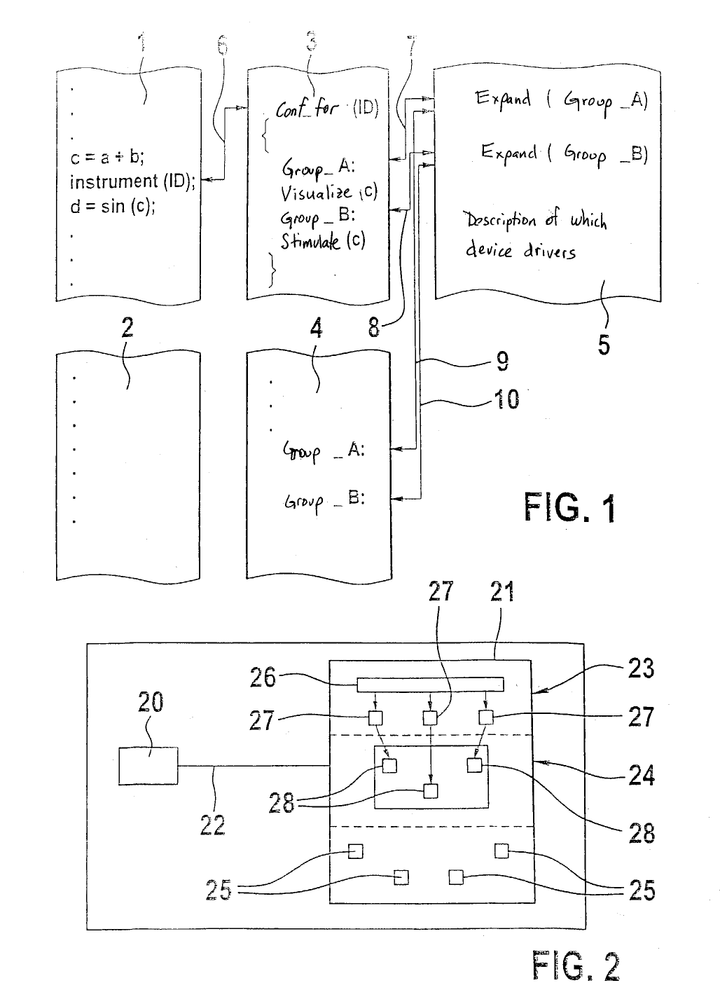

FIG. 1 is intended to elucidate the mode of operation of the method according to the present invention. A first application program 1 and a second application program 2 can be seen. A first local configuration file 3 and a second local configuration file 4 are also shown. Moreover, the drawing shows a global configuration file 5.

Application program 1 contains the program code which, in compiled form, is used at a later time on the destination system. The expression “instrument (ID)” is an allowance of an abstract interface, thus a possible access point to the application program for reading and/or manipulating its internal data. Local first configuration file 1 contains descriptions for the reading (visualization) and writing (stimulation) of the quantity c of the application program. However, for example, quantity a could also be accessed via the identifier ID. Arrow 6 clarifies the expansion of the interface configuration from first local configuration file 3 to application program 1. In first configuration file 3, the interface descriptions are subdivided into two groups, namely, group A and group B. As here, the grouping may be based on the type of interface configuration (reading, writing). However, a functional grouping is also possible, so that individual functions of the application program may be selected.

In global configuration file 5, different configurations are combined in the groups group_A and group_B. Here, global configuration file 5 makes the following specifications: Carry out the configurations of group_A and do not carry out the configurations of group_B. These specifications hold true for all local configuration files. The access of global configuration file 5 to first local configuration file 3 is clarified by arrows 7 and 8; the access to second configuration file 4 is clarified by arrows 9 and 10.

The actions (reading of the data files, setting up a data base, expansion of the macros, . . . ) are carried out by the configuration program.

In global configuration file 5, it is likewise described which physical medium (bus, serial or parallel interface), as well as which protocol are used for accessing data. This information does not have to be stored in the same data file as the information with respect to the groups to be expanded.

FIG. 2 shows a schematic representation of an electronic system 1 for developing software. It has a control unit 20 and a storage medium 21 which are interconnected via a data bus 22. Data bus 22 allows the reading and writing of data. A configuration program 23, an application program 24 and four device drivers 25 are stored in storage medium 21. In this example, all the data are found on one storage medium. However, they may perfectly well be located on a plurality of storage media, as well.

Configuration program 23 includes a global configuration file 26 and three local configuration files 27. Local configuration files 27 contain the data for the description of the interfaces. That is to say, they contain descriptions for the reading and writing of data in application program 24. Global configuration file 26 is higher-order. It implements project-specific settings. This means that it contains information as to which interface descriptions or which groups of interface descriptions in local configuration files 27 should be expanded into application program 24. These actions are carried out by configuration program 23.

Three access points 28 are implemented in application program 24. Access points 28 are locations in application program 24 at which internal data of the application program are possibly accessed, i.e. internal data of the application program are to be read and/or written at these locations. According to global configuration file 8, the necessary data for the description of the interfaces are allocated from local configuration files 27 to access points 28 in application program 24 and expanded into it. Configuration program 23 accomplishes this. Starting from access points 28, it is possible to access data of application program 24. The data for the description of the interfaces are expanded into executable application program 24 by settings in global configuration file 26.

Therefore, the method described runs on the development computer. The internal data of application program 24 is accessed during the program development. An application program is developed for the destination system which offers the specified possibilities of access to data of the destination system. Only these specified access possibilities are contained in the application program. Descriptions of interfaces which were only needed during the program development are no longer contained in the completed application program. This saves resources. The code of the application program is separate from the interface descriptions. Therefore, the application program is able to be reused independently of the interfaces.

Complex accesses via the interfaces are able to be activated and deactivated by a few changes in global configuration file 26. The accesses are independent of the transmission medium and independent of the protocol used.

Device drivers 25 are linked with the linker according to need. They remain in application program 24 according to need and are reused in compiled application program 24 on the destination system.

For example, ten reading and two writing accesses are necessary for the coupling of a function prototype. They are existing variables such as engine speed, temperature, etc. The programmer identifies the variables in the application program sources and possibly supplements the accesses in local configuration files 27. As a rule, changes of the application program sources are not necessary. The necessary configurations are combined to form a group prot_1. A configuration may belong to no, one or more than one group. By activating group prot_1 in the local configuration, a program is produced with the specified interface. After deactivation, the interface is no longer contained in the executable program. The program produced having the specified interface therefore runs on the development computer. The access via the specified interface may be used for checking the functioning of the program. The interface is substantially independent of changes of the source of the application program. For recurrent attempts (e.g. further development of an idle-speed controller) in different projects, the interface may simply be activated again.

The executable application program in the destination system contains only the configured interfaces. Whether these accesses are active at the run time or are activated is a function of the selected protocol which is realized by the drivers.

Configurations are preferably processed off-line. In this way, it is possible to save resources and honor real-time demands.

What is claimed is:

1. An electronic system for developing software, comprising a storage medium (21) which can contain an application program (1, 2, 24) to be developed, and a control unit (20) which offers an access to internal data of the application program (1, 2, 24) via at least one interface,
wherein at least one access point (28) is provided in the application program (1, 2, 24), and in the storage medium (21) a configuration program (23) is stored that contains data which describe the at least one interface and are allocated to the at least one access point (28) in the application program (1, 2, 24).

2. The electronic system as recited in claim 1,
wherein the configuration program (23) has at least one global configuration file (5, 26) and at least one local configuration file (3, 4, 27) which contains the data for the description of the at least one interface.

3. The electronic system as recited in claim 2,
wherein a plurality of local configuration files (3, 4, 27) are provided which can each contain the data for the description of at least one of the interfaces.

4. The electronic system as recited in claim 3,
wherein the data for the descriptions of the interfaces can be grouped in the local configuration files (3, 4, 27).

5. The electronic system as recited in one of the preceding claims,
wherein the storage medium (21) contains at least one device driver (25) which is to be linked to the application program (1, 2, 24).

6. A method for accessing internal data of an application program (1, 2, 24) to be developed, having a storage medium,(21) which contains an application program (24), the access taking place via at least one interface, wherein for the access, data for the description of the at least one interface, which are stored in a configuration program (23) in the storage medium (21), are assigned to at least one access point (28) in the application program (1, 2, 24).

7. The method as recited in claim 6,
wherein the configuration program (23) has a global configuration file (5, 26) and at least one local configuration file (3, 4, 27) which contains the data for the description of the at least one interface; and the data for the description of the at least one interface in the at least one local configuration file (3, 4, 27), corresponding to the data contained in the global configuration file (5, 26), are allocated to the at least one access point (28).

8. The method as recited in claim 7,
wherein a plurality of local configuration files (3, 4, 27) are provided which each contain the data for the description of one of the interfaces.

9. The method as recited in claim 8,
wherein the data for the description of the interfaces are grouped in the local configuration files (3, 4, 27).

10. The method as recited in one of claims 6 through 9,
wherein the storage medium (21) contains at least one device driver (25), and upon access to the internal data, it is linked to the application program (1, 2, 24).

11. A data carrier that is used as a storage medium (21) for an electronic system as recited in one of claims 1 through 5, which can accommodate an application program (1, 2, 24) having at least one access point (28) and has a configuration program (23) in which the data for the description of at least one interface are stored.

12. The data carrier as recited in claim 11,
wherein the configuration program (23) has a global configuration file (5, 26) and at least one local configuration file (3, 4, 27).

13. The data carrier as recited in claim 11 or claim 12,
wherein at least one device driver (25) is stored in it.
